(19) United States
(12) Patent Application Publication
(10) Pub. No.: US 2008/0155681 A1
(43) Pub. Date: Jun. 26, 2008

(54) Recording medium, method, system, and device for authenticating user, and IC card

(75) Inventor: Masaki Mukouchi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/905,319

(22) Filed: Sep. 28, 2007

(30) Foreign Application Priority Data
Dec. 22, 2006 (JP) 2006-346285

(51) Int. Cl. G06F 21/00

(52) U.S. Cl. 726/17

(57) ABSTRACT

In an authenticating device, a registered-insertion-count registering processor counts the number of a registered insertion count and causes the registered insertion count to be stored in an integrated circuit (IC) card. At the time of a user authentication, an authenticating-insertion-count registering processor counts an authenticating insertion count (the number of insertion-and-removal) of the IC card and stores the counted authenticating insertion count in a storage unit. Based on the authenticating insertion count stored in authenticating insertion-count data and the registered insertion count stored in registered insertion-count data which is retrieved from the IC card, an authenticating processor executes an authentication of a user.

### BACKGROUND OF THE INVENTION

1. Field of the Invention

The present invention relates to a recording medium, method, system, and a device for authenticating a user, and an integrated circuit (IC) card, which allow a reader to read data stored in the IC card and execute a user authentication, specifically to a recording medium, method, system, and a device for authenticating a user, and an IC card, which can easily prevent unauthorized use of a computer and enhance the security of the computer without causing a user to execute complex operations.

2. Description of the Related Art

Conventionally, a user authentication by using a user identification (ID) and a password is commonly carried out to prevent unauthorized use of a terminal device. However, when carrying out the user authentication using only the user ID and the password, there is a problem that an ill intentioned third person can easily use the terminal device if the user ID and the password are leaked to outside due to any reason.

For the purpose of supplementing such a weak point in the user authentication mentioned above, the user authentication is carried out by combining various types of other user authentication data (biological data such as a fingerprint, a vein and the like) in addition to the user ID and the password (for example, see Japanese Patent Application Laid-Open No. 2005-338887).

In a technology disclosed in Japanese Patent Application Laid-Open No. 2005-327139, a startup sequence of applications to be executed by a user after logging in to a computer is registered in advance, and the user authentication is carried out by determining whether the user executes the applications according to the registered startup sequence after logging in to the computer.

However, the technologies mentioned above have a problem that, because the user authentication is executed by combining various types of authenticating processes, an operation for the user authentication performed by the user becomes complex and increases authentication data necessary at the time of the user authentication.

Besides, though the user authentication can be performed by using the startup sequence of the applications as disclosed in Japanese Patent Application Laid-Open No. 2005-327139, the user needs to sequentially execute the predetermined applications at the time of starting the computer, and thereby the user is put under significant burden.

In other words, it is a significant challenge to realize a user-authentication which can easily prevent unauthorized use of the computer and enhance the security of the computer without causing the user to execute complex operations.

### SUMMARY OF THE INVENTION

It is an object of the present invention to at least partially solve the problems in the conventional technology.

According to one aspect of the invention, a computer-readable recording medium stores therein a user-authenticating program that causes a computer to perform a user authentication by reading data stored in an integrated circuit (IC) card with a reader, the user-authenticating program causing the computer to execute: counting a number of an insertion-and-removal of the IC card into the reader as insertion-removal data; and executing the user authentication based on a first insertion-removal data which represents insertion-removal data stored in the IC card in advance and a second insertion-removal data which represents the insertion-removal data counted in the counting.

According to another aspect of the invention, a user-authenticating method in which a reader reads data stored in an integrated circuit (IC) card to perform a user authentication includes: counting a number of an insertion-and-removal of the IC card into the reader as insertion-removal data; and executing the user authentication based on a first insertion-removal data which represents insertion-removal data stored in the IC card in advance and a second insertion-removal data which represents the insertion-removal data counted in the counting.

According to still another aspect of the invention, a user-authenticating system in which a reader reads data stored in an integrated circuit (IC) card to perform a user authentication includes: an insertion-removal counting unit that counts a number of an insertion-and-removal of the IC card into the reader as insertion-removal data; and a user-authenticating unit that executes the user authentication based on a first insertion-removal data which represents insertion-removal data stored in the IC card in advance and a second insertion-removal data which represents the insertion-removal data counted in the counting.

According to still another aspect of the invention, a user-authenticating device in which a reader reads data stored in an integrated circuit (IC) card to perform a user authentication includes: an insertion-removal counting unit that counts a number of an insertion-and-removal of the IC card into the reader as insertion-removal data; and a user-authenticating unit that executes the user authentication based on a first insertion-removal data which represents insertion-removal data stored in the IC card in advance and a second insertion-removal data which represents the insertion-removal data counted in the counting.

According to still another aspect of the invention, an IC card which performs data communication with an integrated circuit (IC) card reader provided to a user-authenticating device that performs a user authentication, stores therein insertion-removal data that represents at least one of a number of an insertion-and-removal of the IC card itself within a predetermined time period in the IC card reader, and a time interval of the insertion-and-removal of the IC card, the IC card reader being used for the user authentication performed by the user-authenticating device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining an overview and a feature of an authenticating device according to a first embodiment of the present invention;

FIG. 2 is a functional block diagram of an IC card according to the first embodiment;

FIG. 3 is a functional block diagram of the authenticating device according to the first embodiment;

FIG. 4 is a flowchart of a procedure of a registering process according to the first embodiment;

FIG. 5 is a flowchart of a procedure of an authenticating process according to the first embodiment;

FIG. 6 is a schematic for explaining an overview and a feature of an authenticating device according to a second embodiment of the present invention;

FIG. 7 is a functional block diagram of an IC card according to the second embodiment;

FIG. 8 is a schematic of an example of a data structure of registered insertion interval data according to the second embodiment;

FIG. 9 is a functional block diagram of the authenticating device according to the second embodiment;

FIG. 10 is a schematic of an example of a data structure of authenticating insertion interval data according to the second embodiment;

FIG. 11 is a flowchart of a procedure of a registering process according to the second embodiment;

FIG. 12 is a flowchart of a procedure of an authenticating process according to the second embodiment;

FIG. 13 is a schematic for explaining other authenticating methods; and

FIG. 14 is a block diagram of a computer hardware which forms the authenticating devices shown in FIGS. 2 and 9.

### DETAILED DESCRIPTION OF THE PREFERRED EMBODIMENTS

Exemplary embodiments of a user-authenticating program, a user-authenticating method, and a user-authenticating system according to the present invention will be explained below in detail with reference to the accompanying drawings.

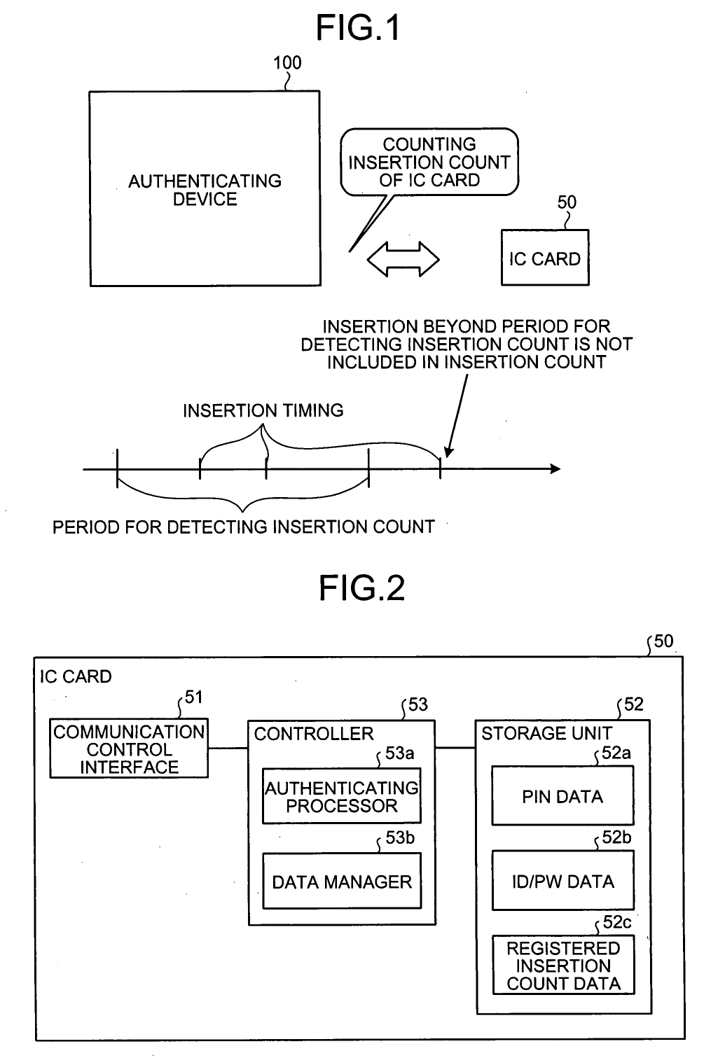

An overview and a feature of an authenticating device according to a first embodiment of the present invention will be explained first. FIG. 1 is a schematic for explaining the overview and the feature of the authenticating device according to the first embodiment. As shown in FIG. 1, in addition to a user authentication using an identification (ID) and a password of a user, an authenticating device 100 according to the first embodiment counts an insertion count of an integrated circuit (IC) card 50 (an insertion count of the IC card 50 to an IC card reader which is not shown) at the time of an authenticating process. The authenticating device 100 compares the counted insertion count and an insertion count of the IC card 50 which is stored in advance in the IC card 50 for the user authentication. Hereinafter, the insertion count which is stored in advance in the IC card 50 for the user authentication will be described as a registered insertion count and the insertion count counted at the time (within a period for detecting the insertion count) of the authenticating process will be described as an authenticating insertion count.

For example, if the registered insertion count stored in the IC card 50 is two and the authenticating insertion count within the period for detecting the insertion count is two (in other words, if the registered insertion count and the authenticating insertion count within the period for detecting the insertion count are equal to each other), the authenticating device 100 authenticates the user (determines that the user is an authorized user). The authenticating device 100 does not count any insertion of the IC card into the IC card 50 beyond the period for detecting the insertion count.

Thus, the authenticating device 100 according to the first embodiment carries out the user authentication based on the registered insertion count stored in the IC card 50 and the authenticating insertion count, and thereby enabling to prevent unauthorized use of a computer (the computer including the authenticating unit 100) and enhance the security of the computer without causing the user to execute complex operations.

Further, the authenticating device 100 according to the first embodiment does not count the insertion of the IC card 50 beyond the period for detecting the insertion count. Thus, the user can execute a dummy insertion of the IC card beyond the period for detecting the insertion count, and easily prevent a fraudulent use of the insertion count with the over-the-shoulder hacking.

Next, structures of the IC card 50 and the authenticating device 100 shown in FIG. 1 will be sequentially explained. FIG. 2 is a functional block diagram of the IC card 50 according to the first embodiment. As shown in FIG. 2, the IC card 50 includes a communication control interface 51, a storage unit 52, and a controller 53.

The communication control interface 51 carries out data communication with the IC card reader (not shown) provided in the authenticating device 100.

The storage unit 52 stores therein data and program necessary for various processes carried out by the controller 53. Especially, as shown in FIG. 2, the storage unit 52 includes personal identification number (PIN) data 52a, identification/password (ID/PW) data 52b, and registered insertion-count data 52c as components closely related to the present invention.

The PIN data 52a authenticates the user who accesses the ID/PW data 52b. The ID/PW data 52b includes the user ID and the password. The registered insertion-count data 52c stores the registered insertion count explained with reference to FIG. 1.

The controller 53 includes an internal memory for storing program and control data which specify various process sequences. The controller 53 uses the stored program and control data to execute various processes. Especially, as shown in FIG. 2, the controller 53 includes an authenticating processor 53a and a data manager 53b as components closely related to the present invention.

Upon receiving a retrieve request of the ID/PW data 52b or a retrieve request of the registered insertion-count data 52c from the authenticating device 100, the authenticating processor 53a carries out authentication. To be specific, upon receiving the retrieve request of the ID/PW data 52b from the authenticating device 100, the authenticating processor 53a requests PIN data from the authenticating device 100, compares the requested PIN data with the PIN data 52a stored in the storage unit 52, and outputs the ID/PW data 52b to the authenticating device 100 if the requested PIN data matches the PIN data 52a.

Upon receiving the retrieve request of the registered insertion-count data 52c, the authenticating processor 53a requests the PIN data from the authenticating device 100, compares the requested PIN data with the PIN data 52a stored in the storage unit 52, and outputs the registered insertion-count data 52c to the authenticating device 100 if the requested PIN data matches the PIN data 52a.

The data manager 53b updates the registered insertion-count data 52c after carrying out the authentication based on the PIN data 52a, when receiving insertion-count data as an updating target from the authenticating device 100. To be specific, upon receiving insertion-count data as the updating target, the data manager 53b requests the PIN data from the authenticating device 100 and compares the requested PIN data with the PIN data 52a stored in the storage unit 52. If the requested PIN data matches the PIN data 52a stored in the storage unit 52, the data manager 53b uses the insertion-count data as the updating target to update the registered insertion-count data 52c stored in the storage unit 52.

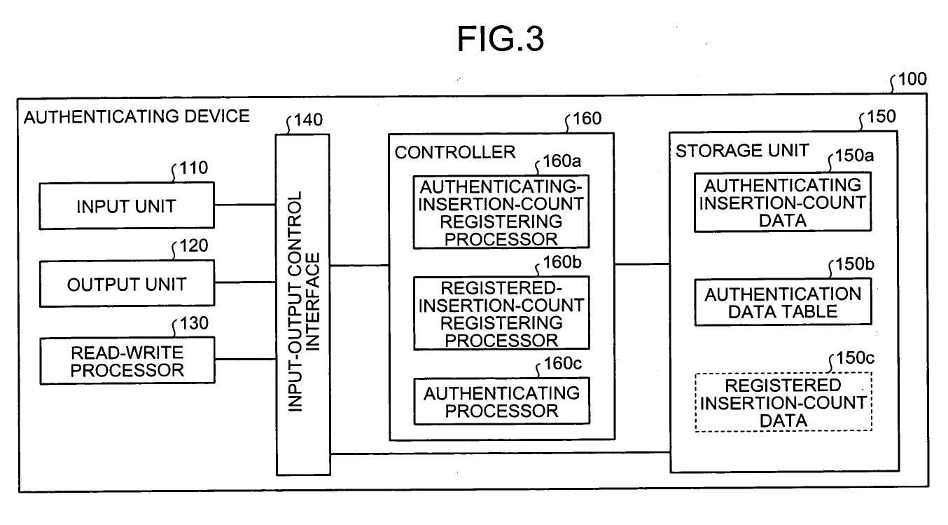

A structure of the authenticating device 100 according to the first embodiment will be explained next. FIG. 3 is a functional block diagram of the authenticating device 100 according to the first embodiment. As shown in FIG. 3, the authenticating device 100 includes an input unit 110, an output unit 120, a read-write processor 130, an input-output control interface 140, a storage unit 150, and a controller 160.

The input unit 110 is an input unit such as a keyboard, a mouse, and a microphone, which inputs various types of data. A monitor (the output unit 120) to be explained later realizes a pointing device function in cooperation with the mouse. The user issues an authentication instruction using the IC card 50 and an instruction to register the insertion count in the IC card 50 via the input unit 110.

The output unit 120 is an output unit such as the monitor (a display or a touch panel) and a speaker, which outputs various types of data.

The read-write processor 130 is a unit (for example, an IC card reader/writer) that writes various types of data to the IC card 50 and reads various types of data stored in the IC card 50. Further, the read-write processor 130 counts the number of insertion of the IC card 50. Any method can be used to count the insertion count of the IC card 50.

For example, if the IC card 50 is a contact type IC card, the read-write processor 130 determines whether the IC card 50 is in contact with a terminal for connecting the IC card 50, and can count the insertion count based on a contact and a noncontact of the IC card 50 when the IC card 50 is inserted and removed. If the IC card 50 is a non-contact type IC card, the read-write processor 130 can count the insertion count based on whether a wireless data access to the IC card 50 is enabled.

The input-output control interface 140 controls data input/output performed by the input unit 110, the output unit 120, the read-write processor 130, the storage unit 150, and the controller 160.

The storage unit 150 stores therein data and program necessary for various processes performed by the controller 160. Especially, as shown in FIG. 3, the storage unit 150 includes authenticating insertion-count data 150a, an authentication data table 150b, and registered insertion-count data 150c as components closely related to the present invention.

The authenticating insertion-count data 150a stores the authenticating insertion count explained with reference to FIG. 1. The authentication data table 150b establishes and stores therein a correspondence between the user ID and the password. The registered insertion-count data 150c is registered insertion-count data retrieved from the IC card 50.

The controller 160 includes an internal memory for storing program and control data which specify various process sequences. The controller 160 uses the stored program and control data to execute various processes. Especially, as shown in FIG. 3, the controller 160 includes an authenticating-insertion-count registering processor 160a, a registered-insertion-count registering processor 160b, and an authenticating processor 160c as components closely related to the present invention.

The authenticating-insertion-count registering processor 160a stores the authenticating insertion count in the authenticating insertion-count data 150a. To be specific, upon receiving the authentication instruction from the input unit 110, the authenticating-insertion-count registering processor 160a counts the insertion count of the IC card 50 during the period for detecting the insertion count in cooperation with the read-write processor 130, and stores the counted authenticating insertion count in the authenticating insertion-count data 150a.

The registered-insertion-count registering processor 160b stores the registered insertion count in the IC card 50. To be specific, upon receiving a registering instruction to register the registered insertion count in the IC card 50 from the input unit 110, the registered-insertion-count registering processor 160b counts the insertion count of the IC card 50 in cooperation with the read-write processor 130, and outputs the counted insertion count to the IC card 50 to store the registered insertion count in the IC card 50.

Further, when outputting the registered insertion count to the IC card 50, the registered-insertion-count registering processor 160b requests the PIN data from the user (causes the output unit 120 to display an instruction to input the PIN data), retrieves the PIN data input from the input unit 110, outputs the retrieved PIN data to the IC card 50, together with the registered insertion count.

The registered-insertion-count registering processor 160b can use any method to count the insertion count. For example, the registered-insertion-count registering processor 160b can count the insertion count within a fixed period after receiving the registering instruction or within a registering period which is instructed from the input unit 110 (a registering button may be provided in the authenticating device 100 and a time period when the registering button is pressed by the user may be treated as the registering period to count the insertion count).

Based on the authenticating insertion count stored in the authenticating insertion-count data 150a and the registered insertion count stored in the registered insertion-count data 150c which is retrieved from the IC card 50, the authenticating processor 160c executes the user authentication.

A process performed by the authenticating processor 160c will be explained specifically. The authenticating processor 160c requests the PIN data from the user (causes the output unit 120 to display an instruction to input the PIN data) and retrieves the PIN data input from the input unit 110. The authenticating processor 160c outputs the retrieved PIN data to the IC card 50, and requests the registered insertion-count data and the ID/PW data from the IC card 50.

Next, the authenticating processor 160c retrieves the registered insertion-count data and the ID/PW data from the IC card 50, and stores the registered insertion-count data in the storage unit 150. Then, the authenticating processor 160c compares the ID/PW data with the authentication data table 150b and determines whether a combination of the user ID and the password included in the retrieved ID/PW data is present in the authentication data table 150b. If the combination of the user ID and the password is not present in the authentication data table 150b, the authenticating processor 160c outputs an error in the output unit 120.

If the combination of the user ID and the password included in the ID/PW data is present in the authentication data table 150b, the authenticating processor 160c compares the authenticating insertion count stored in the authenticating insertion-count data 150a with the registered insertion count stored in the registered insertion-count data 150c which is retrieved from the IC card 50, and determines whether the authenticating insertion count matches the registered insertion count. If the authenticating insertion count does not match the registered insertion count, the authenticating processor 160c outputs an error in the output unit 120.

Upon comparing the authenticating insertion count stored in the authenticating insertion-count data 150a with the registered insertion count stored in the registered insertion-count data 150c which is retrieved from the IC card 50, if the authenticating insertion count matches the registered insertion count, the authenticating processor 160c determines that the authentication is successful and permits various types of operations on the authenticating device 100.

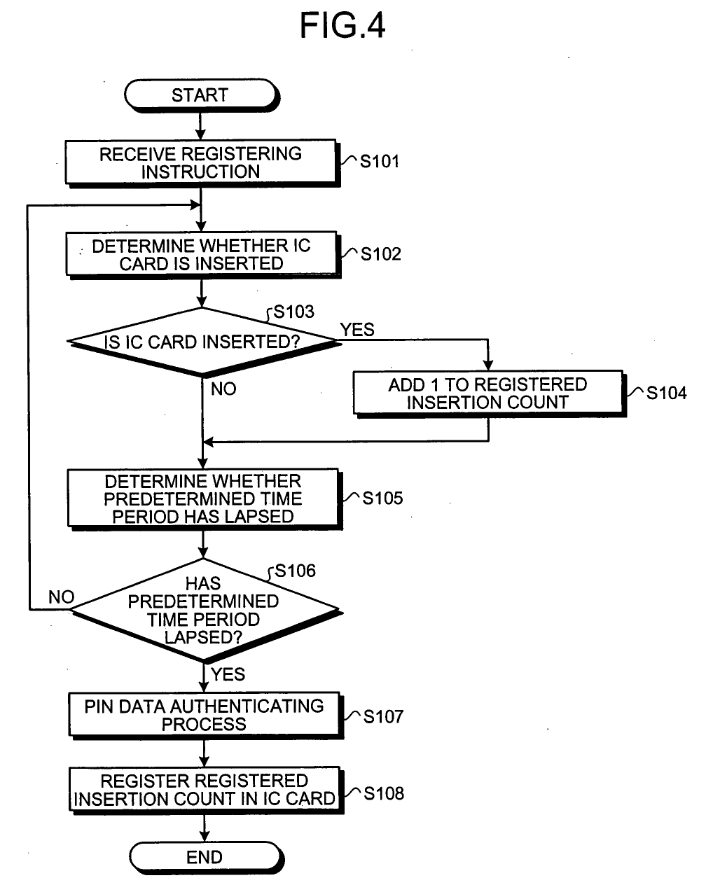

A procedure of a registering process according to the first embodiment will be explained next. FIG. 4 is a flowchart of the registering process according to the first embodiment. As shown in FIG. 4, the registered-insertion-count registering processor 160b of the authenticating device 100 receives the registering instruction from the input unit 110 (step S101) and determines whether the IC card 50 is inserted (step S102).

If the IC card 50 is inserted (“Yes” at step S103), the registered-insertion-count registering processor 160b adds one to the registered insertion count (an initial value of the registered insertion count is zero) (step S104) and determines whether a predetermined time period has lapsed (step S105). If the IC card 50 is not inserted (inserted and removed) (“No” at step S103), the registering process moves to step S105. Since whether the IC card 50 is inserted at step S103 is determined based on whether the IC card 50 is inserted and removed, if the IC card 50 is kept inserted without removing, the registered-insertion-count registering processor 160b determines at step S103 that the IC card 50 is not inserted.

If the predetermined time period has not lapsed (“No” at step S106), the registering process moves to step S102. If the predetermined time period has lapsed (“Yes” at step S106), the authenticating processor 160c executes a PIN data authenticating process between the authenticating device 100 and the IC card 50 (step S107). If the PIN data authenticating process is successful, the registered-insertion-count registering processor 160b registers the registered insertion-count data in the IC card 50 (step S108).

The registered-insertion-count registering processor 160b counts the registered insertion count and registers the registered insertion count in the IC card 50. Therefore, the user can easily change the insertion count of the IC card 50 and can also enhance the security of the user authentication using the IC card 50.

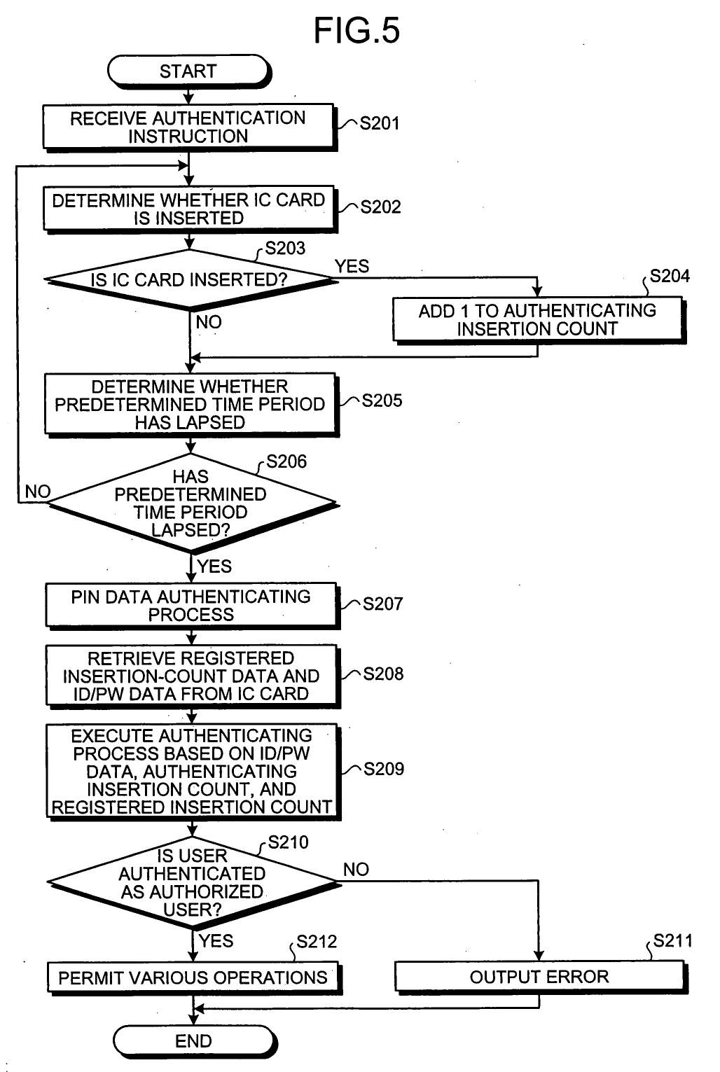

A procedure of the authenticating process according to the first embodiment will be explained next. FIG. 5 is a flowchart of the authenticating process according to the first embodiment. As shown in FIG. 5, the authenticating-insertion-count registering processor 160a of the authenticating device 100 receives the authentication instruction (step S201) and determines whether the IC card 50 is inserted (step S202).

If the IC card 50 is inserted (“Yes” at step S203), the authenticating-insertion-count registering processor 160a adds one to the authenticating insertion count (an initial value of the authenticating insertion count is zero) (step S204) and determines whether the predetermined time period has lapsed (step S205). On the other hand, if the IC card 50 is not inserted (inserted and removed) (“No” at step S203), the authenticating process moves to step S205. Since whether the IC card 50 is inserted at step S203 is determined based on whether the IC card 50 is inserted and removed, if the IC card 50 is kept inserted without removing, the authenticating-insertion-count registering processor 160a determines at step S203 that the IC card 50 is not inserted.

If the predetermined time period has not lapsed (“No” at step S206), the registering process moves to step S202. If the predetermined time period has lapsed (“Yes” at step S206), the authenticating processor 160c executes the PIN data authenticating process between the authenticating device 100 and the IC card 50 (step S207). If the PIN data authenticating process is successful, the authenticating-insertion-count registering processor 160a retrieves the registered insertion-count data and the ID/PW data from the IC card 50 (step S208).

Based on the ID/PW data, the authenticating insertion count, and the registered insertion count, the authenticating processor 160c executes the authenticating process (step S209). If the user cannot be authenticated as an authorized user (“No” at step S210), the authenticating processor 160c outputs an error in the output unit 120 (step S211). If the user is authenticated as an authorized user (“Yes” at step S210), the authenticating processor 160c permits various types of operations on the computer (not shown) including the authenticating device 100 (step S212).

The authenticating processor 160c executes the authenticating process based on the authenticating insertion count and the registered insertion count. Therefore, a fraudulent use of the computer including the authenticating device can be prevented without causing the user to execute complex operations.

In the authenticating device 100 according to the first embodiment, the registered-insertion-count registering processor 160b counts the registered insertion count in advance and causes the registered insertion count to be stored in the IC card 50. When carrying out the user authentication, the authenticating-insertion-count registering processor 160a counts the authenticating insertion count (insertion and removal count) of the IC card 50 and stores the counted authenticating insertion count in the storage unit 150. Then, the authenticating processor 160c executes the authentication of the user based on the authenticating insertion count stored in the authenticating insertion-count data 150a and the registered insertion count stored in the registered insertion-count data 150c which is retrieved from the IC card 50. Thus, a fraudulent use of the computer can be easily prevented without causing the user to execute complex operations and the security of the computer can be enhanced.

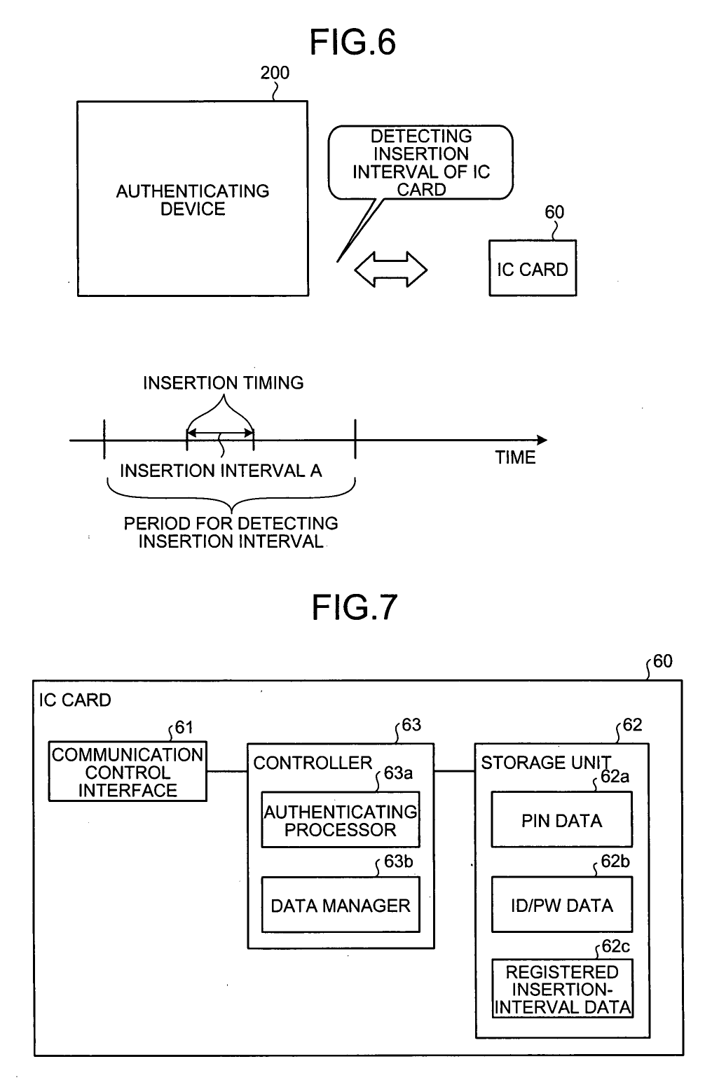

An overview and a feature of an authenticating device according to a second embodiment of the present invention will be explained next. FIG. 6 is a schematic for explaining the overview and the feature of the authenticating device according to the second embodiment. As shown in FIG. 6, in addition to the user authentication using the user ID and the password, an authenticating device 200 according to the second embodiment measures (counts) insertion an interval of an IC card 60 at the time of the authenticating process. The authenticating device 200 compares the measured insertion interval with an insertion interval of the IC card 60 which is stored in the IC card 60 in advance to execute the user authentication. Hereinafter, the insertion interval stored in the IC card 60 in advance for the user authentication will be described as a registered insertion interval, and the insertion interval measured at the time of the authenticating process (within a period for detecting the insertion interval) will be described as an authenticating insertion interval.

For example, if a registered insertion interval stored in the IC card 60 is A and an authenticating insertion interval within the period for detecting the insertion interval is A (in other words, if the registered insertion interval is equal to the authenticating insertion interval within the period for detecting the insertion interval), the authenticating device 200 authenticates the user (determines that the user is an authorized user). The authenticating device 200 does not measure any insertion interval of the IC card 60 beyond the period for detecting the insertion interval.

Thus, the authenticating device 200 according to the second embodiment carries out the user authentication based on the registered insertion interval stored in the IC card 60 and the authenticating insertion interval, thereby enabling to prevent a fraudulent use of the computer (the computer including the authenticating unit 200) and enhance the security of the computer without causing the user to execute complex operations.

Further, the authenticating device 200 according to the second embodiment does not measure any insertion interval of the IC card 60 beyond the period for detecting the insertion interval. Thus, the user can execute a dummy insertion of the IC card 60 beyond the period, and easily prevent the fraudulent use of the insertion interval with the over-the-shoulder hacking.

Structures of the IC card 60 and the authenticating device 200 shown in FIG. 6 will be sequentially explained. FIG. 7 is a functional block diagram of the IC card 60 according to the second embodiment. As shown in FIG. 7, the IC card 60 includes a communication control interface 61, a storage unit 62, and a controller 63.

The communication control interface 61 carries out data communication with an IC card reader (not shown) provided in the authenticating device 200.

The storage unit 62 stores therein data and program necessary for various processes carried out by the controller 63. Especially, as shown in FIG. 7, the storage unit 62 includes PIN data 62a, ID/PW data 62b, and registered insertion-interval data 62c as components closely related to the present invention.

The PIN data 62a authenticates the user who accesses the ID/PW data 62b. The ID/PW data 62b includes the user ID and the password. The registered insertion-interval data 62c stores the registered insertion interval explained with reference to FIG. 6.

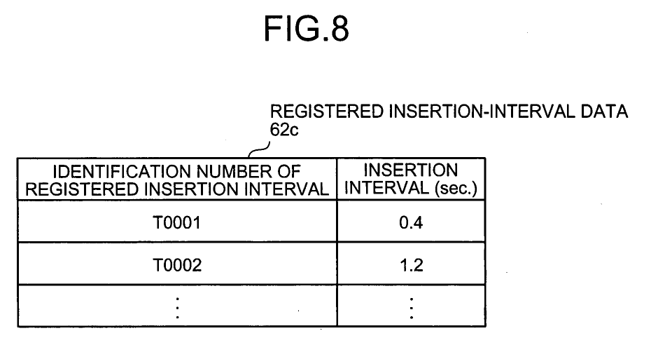

FIG. 8 is a schematic of an example of a data structure of the registered insertion-interval data 62c according to the second embodiment. As shown in FIG. 8, the registered insertion-interval data 62c establishes and stores a correspondence between an identification number of registered insertion interval which identifies each registered insertion interval and the insertion interval. For example, an insertion interval of “0.4 seconds” corresponding to the identification number of registered insertion interval “T0001” is stored in a first row of the registered insertion-interval data 62c in FIG. 8.

The controller 63 includes an internal memory for storing program and control data which specify various process sequences. The controller 63 uses the stored program and the control data to execute various processes. Especially, as shown in FIG. 7, the controller 63 includes an authenticating processor 63a and a data manager 63b as components closely related to the present invention.

Upon receiving a retrieve request of the ID/PW data 62b or a retrieve request of the registered insertion-interval data 62c from the authenticating device 200, the authenticating processor 63a carries out authentication. To be specific, upon receiving the retrieve request of the ID/PW data 62b from the authenticating device 200, the authenticating processor 63a requests the PIN data from the authenticating device 200, compares the requested PIN data with the PIN data 62a stored in the storage unit 62, and outputs the ID/PW data 62b to the authenticating device 200 if the requested PIN data matches the PIN data 62a.

Upon receiving the retrieve request of the registered insertion-interval data 62c, the authenticating processor 63a requests the PIN data from the authenticating device 200, compares the requested PIN data with the PIN data 62a stored in the storage unit 62, and outputs the registered insertion-interval data 62c to the authenticating device 200 if the requested PIN data matches the PIN data 62a.

The data manager 63b updates the registered insertion-interval data 62c after carrying out the authentication based on the PIN data 62a, when receiving insertion-interval data as an updating target from the authenticating device 200. To be specific, upon receiving insertion-interval data as the updating target, the data manager 63b requests the PIN data from the authenticating device 200 and compares the requested PIN data with the PIN data 62a stored in the storage unit 62. If the requested PIN data matches the PIN data 62a stored in the storage unit 62, the data manager 63b uses the insertion-interval data as the updating target to update the registered insertion-interval data 62c stored in the storage unit 62.

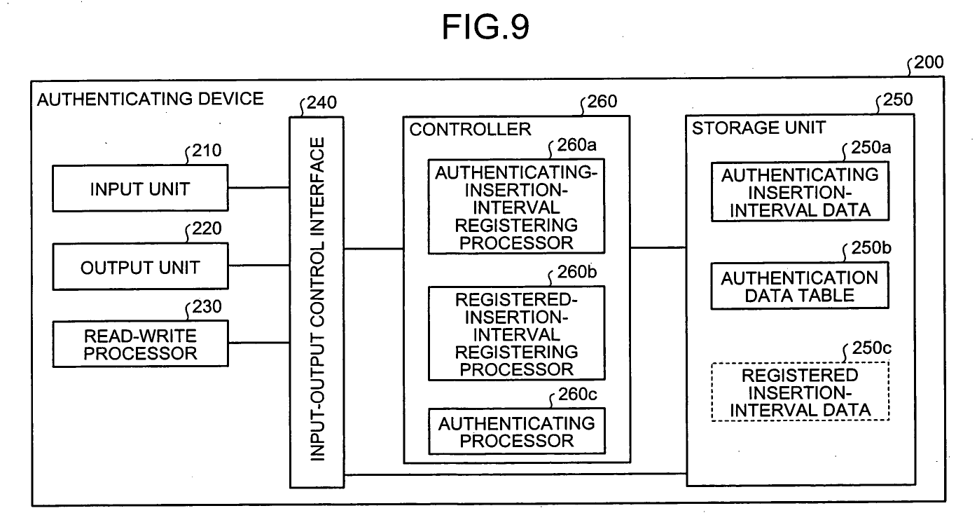

A structure of the authenticating device 200 according to the second embodiment will be explained next. FIG. 9 is a functional block diagram of the authenticating device 200 according to the second embodiment. As shown in FIG. 9, the authenticating device 200 includes an input unit 210, an output unit 220, a read-write processor 230, an input-output control interface 240, a storage unit 250, and a controller 260.

The input unit 210 is an input unit such as a keyboard, a mouse, and a microphone, which inputs various types of data. A monitor (the output unit 220) to be explained later realizes the pointing device function in cooperation with the mouse. The user issues the authentication instruction using the IC card 60 and the instruction to register the insertion interval in the IC card 60 via the input unit 210.

The output unit 220 is an output unit such as the monitor (a display or a touch panel), and a speaker, which outputs various types of data.

The read-write processor 230 is a unit (for example, the IC card reader/writer) that writes various types of data to the IC card 60 and reads various types of data stored in the IC card 60. Further, the read-write processor 230 measures the insertion interval when the IC card 60 is inserted and removed. Any method can be used to count the insertion interval of the IC card 50.

For example, if the IC card 60 is a contact type IC card, the read-write processor 230 determines whether the IC card 60 is in contact with a terminal for connecting the IC card 60, and can count the insertion interval by measuring the interval of the timing during which the IC card 60 is in contact with the terminal when the IC card 60 is inserted and removed. If the IC card 60 is a noncontact type IC card, the read-write processor 230 can count the insertion interval by measuring the interval of the timing during which a wireless data access to the IC card 60 is enabled.

The input-output control interface 240 controls data input/output performed by the input unit 210, the output unit 220, the read-write processor 230, the storage unit 250, and the controller 260.

The storage unit 250 stores therein data and program necessary for various processes performed by the controller 260. Especially, as shown in FIG. 9, the storage unit 250 includes authenticating insertion-interval data 250a, an authentication data table 250b, and registered insertion-interval data 250c as components closely related to the present invention.

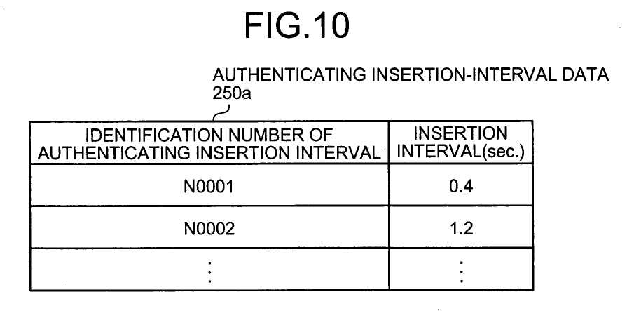

The authenticating insertion-interval data 250a stores the authenticating insertion interval explained with reference to FIG. 6. FIG. 10 is a schematic of an example of a data structure of the authenticating insertion-interval data according to the second embodiment. As shown in FIG. 10, the authenticating insertion-interval data 250a establishes and stores a correspondence between an identification number of authenticating insertion interval which identifies each authenticating insertion interval and the insertion interval. For example, an insertion interval of “0.4 seconds” corresponding to the identification number of authenticating insertion interval “N0001” is stored in a first row of the authenticating insertion-interval data 250a in FIG. 10.

The controller 260 includes an internal memory for storing program and control data which specify various process sequences. The controller 260 uses the stored program and the control data to execute various processes. Especially, as shown in FIG. 9, the controller 260 includes an authenticating-insertion-interval registering processor 260a, a registered-insertion-interval registering processor 260b, and an authenticating processor 260c as components closely related to the present invention.

The authenticating-insertion-interval registering processor 260a stores the authenticating insertion interval in the authenticating insertion-interval data 250a. To be specific, upon receiving the authentication instruction from the input unit 210, the authenticating-insertion-interval registering processor 260a measures the insertion interval of the IC card 60 during the period for detecting the insertion interval in cooperation with the read-write processor 230, and stores the measured authenticating insertion interval in the authenticating insertion-interval data 250a.

The registered-insertion-interval registering processor 260b stores the registered insertion interval in the IC card 60. To be specific, upon receiving a registering instruction to register the registered insertion interval in the IC card 60 from the input unit 210, the registered-insertion-interval registering processor 260b measures the insertion interval of the IC card 60 in cooperation with the read-write processor 230, and outputs the measured insertion interval to the IC card 60 to store the registered insertion interval in the IC card 60.

Further, when outputting the registered insertion interval to the IC card 60, the registered-insertion-interval registering processor 260b requests the PIN data from the user (causes the output unit 220 to display an instruction to input the PIN data), retrieves the PIN data input from the input unit 210, outputs the retrieved PIN data to the IC card 60, together with the registered insertion interval.

The registered-insertion-count registering processor 260b can use any method to measure the registered insertion interval. For example, the registered-insertion-interval registering processor 260b can measure the insertion interval within a fixed period after receiving the registering instruction or within a registering period which is instructed from the input unit 210 (a registering button may be provided in the authenticating device 200 and a time period when the registering button is pressed by the user may be treated as the registering period to count the registered insertion interval).

Based on the authenticating insertion interval stored in the authenticating insertion-interval data 250a and the registered insertion interval stored in the registered insertion-interval data 250c which is retrieved from the IC card 60, the authenticating processor 260c executes the user authentication.

A process performed by the authenticating processor 260c will be explained specifically. The authenticating processor 260c requests the PIN data from the user (causes the output unit 220 to display the instruction to input the PIN data) and retrieves the PIN data input from the input unit 210. The authenticating processor 260c outputs the retrieved PIN data to the IC card 60, and requests the registered insertion-interval data and the ID/PW data from the IC card 60.

Next, the authenticating processor 260c retrieves the registered insertion-interval data and the ID/PW data from the IC card 60, and stores the registered insertion-interval data in the storage unit 250. Then, the authenticating processor 260c compares the ID/PW data with the authentication data table 250b and determines whether a combination of the user ID and the password included in the retrieved ID/PW data is present in the authentication data table 250b. If the combination of the user ID and the password is not present in the authentication data table 250b, the authenticating processor 260c outputs an error in the output unit 220.

If the combination of the user ID and the password included in the ID/PW data is present in the authentication data table 250b, the authenticating processor 260c compares the authenticating insertion interval stored in the authenticating insertion-interval data 250a with the registered insertion interval stored in the registered insertion-interval data 250c which is retrieved from the IC card 60, and determines whether the authenticating insertion interval matches the registered insertion interval. If the authenticating insertion interval does not match the registered insertion interval, the authenticating processor 260c outputs an error in the output unit 220.

Upon comparing the authenticating insertion interval stored in the authenticating insertion-interval data 250a with the registered insertion interval stored in the registered insertion-interval data 250c which is retrieved from the IC card 60, if the authenticating insertion interval matches the registered insertion interval, the authenticating processor 260c determines that the authentication is successful and permits various types of operations on the authenticating device 200.

A process of the authenticating processor 260c by using the registered insertion-interval data shown in FIG. 8 and the authenticating insertion-interval data shown in FIG. 10 will be explained. The insertion interval “0.4 seconds” of the identification number of registered insertion interval “T0001” matches the insertion interval “0.4 seconds” of the identification number of authenticating insertion interval “N0001”. Similarly, the insertion interval “1.2 seconds” of the identification number of registered insertion interval “T0002” matches the insertion interval “1.2 seconds” of the identification number of authenticating insertion interval “N0002”. Thus, the authenticating processor 260c determines that the authentication is successful.

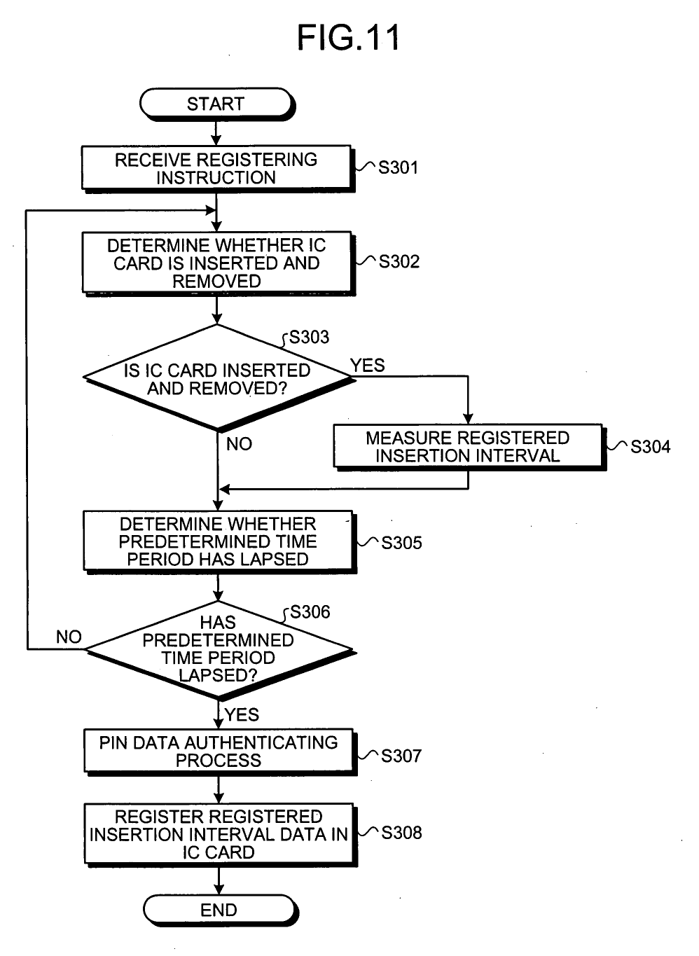

A procedure of a registering process according to the second embodiment will be explained next. FIG. 11 is a flowchart of the registering process according to the second embodiment. As shown in FIG. 11, the registered-insertion-interval registering processor 260b of the authenticating device 200 receives the registering instruction from the input unit 210 (step S301) and determines whether the IC card 60 is inserted and removed (step S302).

If the IC card 60 is inserted and removed (“Yes” at step S303), the registered-insertion-interval registering processor 260b measures the registered insertion interval (step S304) and determines whether a predetermined time period has lapsed (step S305). If the IC card 60 is not inserted and removed (“No” at step S303), the registering process moves to step S305.

If the predetermined time period has not lapsed (“No” at step S306), the registering process moves to step S302. If the predetermined time period has lapsed (“Yes” at step S306), the authenticating processor 260c executes the PIN data authenticating process between the authenticating device 200 and the IC card 60 (step S307). If the PIN data authenticating process is successful, the registered-insertion-interval registering processor 260b registers the registered insertion interval in the IC card 60 (step S308).

The registered-insertion-interval registering processor 260b measures the registered insertion interval and registers the registered insertion interval in the IC card 60. Therefore, the user can easily change the insertion interval of the IC card 60 and can enhance the security of the user authentication using the IC card 60.

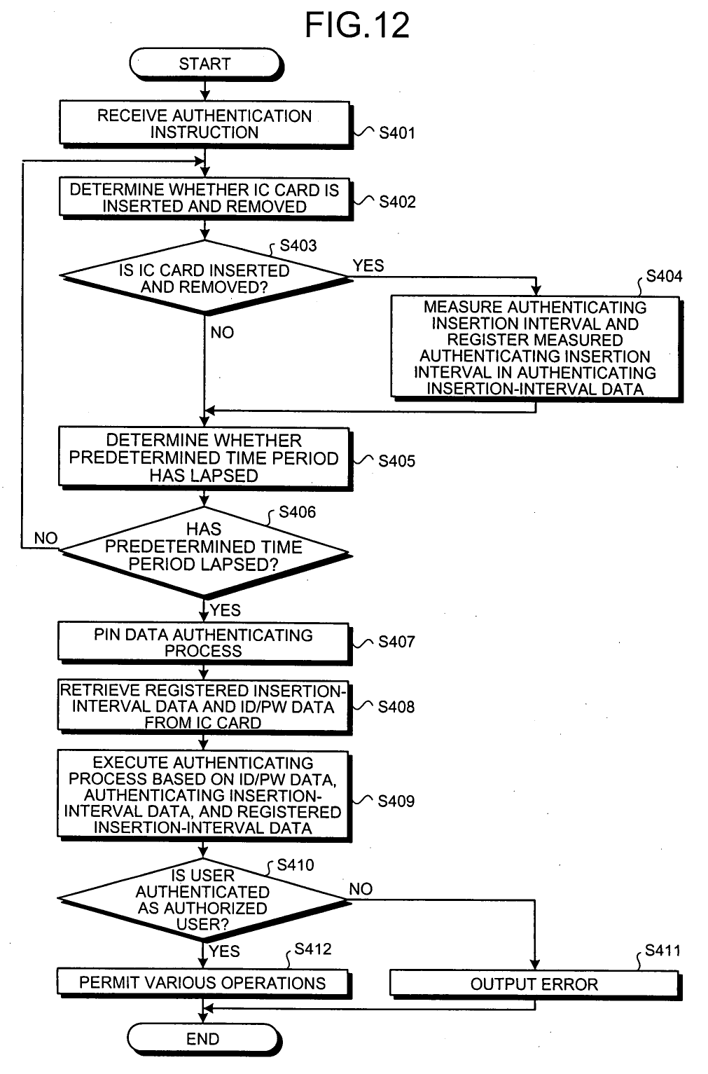

A procedure of the authenticating process according to the second embodiment will be explained next. FIG. 12 is a flowchart of the authenticating process according to the second embodiment. As shown in FIG. 12, the authenticating-insertion-interval registering processor 260a of the authenticating device 200 receives the authentication instruction (step S401) and determines whether the IC card 60 is inserted and removed (step S402).

If the IC card 60 is inserted and removed (“Yes” at step S403), the authenticating-insertion-interval registering processor 260a measures the authenticating insertion interval, registers the measured authenticating insertion interval in the authenticating insertion-interval data 250a (step S404), and determines whether the predetermined time period has lapsed (step S405). If the IC card 60 is not inserted and removed (“No” at step S403), the authenticating process moves to step S405.

If the predetermined time period has not lapsed (“No” at step S406), the authenticating process moves to step S402. If the predetermined time period has lapsed (“Yes” at step S406), the authenticating processor 260c executes the PIN data authenticating process between the authenticating device 200 and the IC card 60 (step S407). If the PIN data authenticating process is successful, the authenticating processor 260c retrieves the registered insertion-interval data and the ID/PW data from the IC card 60 (step S408).

Based on the ID/PW data, the authenticating insertion interval, and the registered insertion interval, the authenticating processor 260c executes the authenticating process (step S409). If the user cannot be authenticated as an authorized user (“No” at step S410), the authenticating processor 260c outputs an error in the output unit 220. If the user is authenticated as an authorized user (“Yes” at step S410), the authenticating processor 260c permits various types of operations on the computer (not shown) including the authenticating device 200 (step S412).

The authenticating processor 260c executes the authenticating process based on the authenticating insertion interval and the registered insertion interval. Therefore, a fraudulent use of the computer including the authenticating device can be prevented without causing the user to execute complex operations.

In the authenticating device 200 according to the second embodiment, the registered-insertion-interval registering processor 260b measures the registered insertion interval in advance and causes the registered insertion interval to be stored in the IC card 60. When carrying out the user authentication, the authenticating-insertion-interval registering processor 260a measures the authenticating insertion interval of the IC card 60 and causes the measured authenticating insertion interval to be stored in the storage unit 250. Then, the authenticating processor 260c executes the authentication of the user based on the authenticating insertion interval stored in the authenticating insertion-interval data 250a and the registered insertion interval stored in the registered insertion-interval data 250c which is retrieved from the IC card 60. Thus, a fraudulent use of the computer can be easily prevented and the security of the computer can be enhanced without causing the user to execute complex operations.

Though the first and the second embodiments are explained above, various modifications apart from the first and the second embodiments can also be made in the present invention. Other modifications of the present invention will be explained below in a third embodiment of the present invention.

### (1) Other Authenticating Methods

In the first embodiment, the authenticating device 100 carries out the user authentication based on the insertion count of the IC card 50. In the second embodiment, the authenticating device 200 carries out the user authentication based on the insertion interval of the IC card 60. However, the user authentication may be carried out by combining both authentications of the first and the second embodiments. In other words, the authenticating device can execute the user authentication by using both the insertion count and the insertion interval of the IC card, thereby enabling to further enhance the security of the computer including the authenticating device.

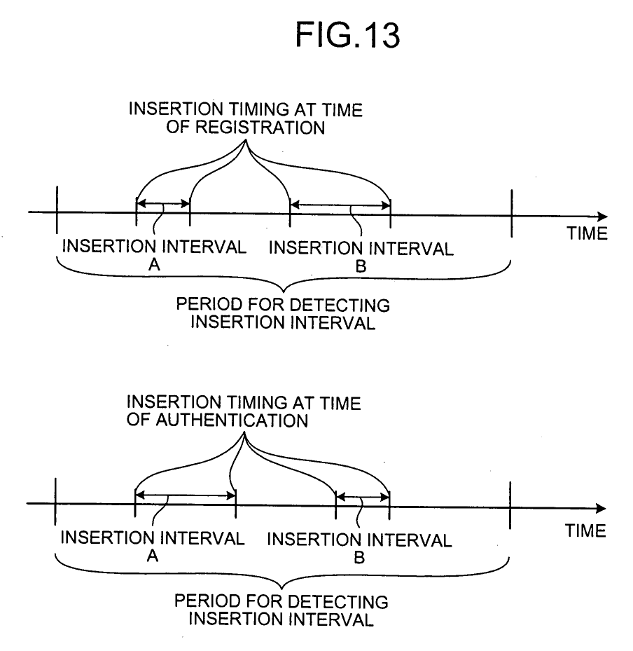

In the second embodiment, the authenticating device 200 executes the user authentication based on the insertion interval of the IC card 60. However, the authenticating device 200 can also authenticate the user as an authorized user even if a sequence of the registered insertion interval stored in the IC card 60 does not match a sequence of the authenticating insertion interval. FIG. 13 is a schematic for explaining other authenticating methods. As shown in FIG. 13, at the time of registering, the registered insertion intervals are registered in a sequence of an insertion interval A followed by an insertion interval B in the IC card 60. When the IC card 60 is inserted and removed in a sequence of the insertion interval B followed by the insertion interval A at the time of user authentication, the authenticating device 200 authenticates the user as an authorized user because each insertion interval is equal to each other, irrespective of the different sequence. Thus, the operation performed by the user is further simplified by using only the insertion interval for the user authentication and ignoring the sequence of the insertion interval.

In the second embodiment, the authenticating device 200 executes the user authentication based on the insertion interval of the IC card 60. However, since matching of the registered insertion interval and the authentication of the insertion interval are required as the condition for the authentication, and the insertion interval is registered by 0.1 seconds in the registered insertion-interval data shown in FIG. 8 for example, meticulous insertion timing is necessitated. To overcome this weak point, the authenticating processor 260c shown in FIG. 9 may authenticate the user as an authorized user even if the registered insertion interval do not completely match the authenticating insertion interval. For example, if the registered insertion interval is A seconds, and the authenticating insertion interval of B seconds is within a predetermined threshold value (A−α<B<A+β where α and β are predetermined numerical values), the authenticating processor 260c may authenticate the user as an authorized user. Such an authenticating method as mentioned above to authenticate the user enables to eliminate extreme accuracy related to the insertion interval of the IC card 60, thus enabling to reduce the burden on the user.

### (2) System Structure and the Like

The automatic processes explained in the present embodiment may be, entirely or in part, carried out manually. Similarly, the manual processes explained in the present embodiment may be, entirely or in part, carried out automatically by a known method. The procedure described above and shown in the drawings, the control procedure, specific names, and data including various parameters can be changed as required unless otherwise specified.

The components of the authenticating devices 100 and 200 shown in the drawings are merely conceptual, and may not necessarily physically have the same structures. In other words, a specific configuration, disintegration and integration, of each device is not limited to the configuration shown in the drawings. The device, as a whole or in part in an arbitrary unit, can be disintegrated and integrated functionally or physically in accordance with the load or the status of use. Further, the process functions performed by the device are, entirely or in part, realized by a CPU or a program executed by the CPU, or by a hardware using wired logic.

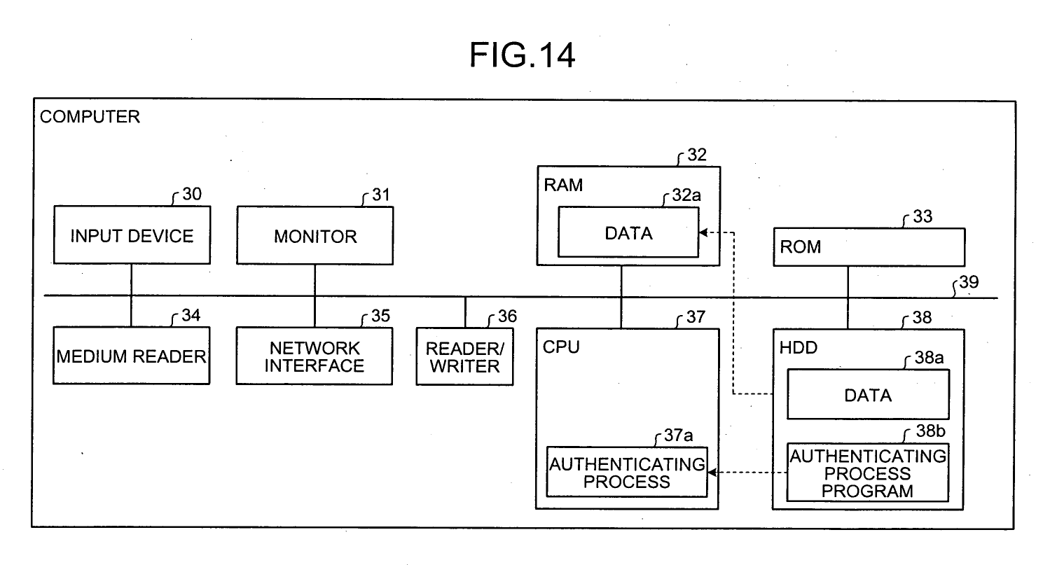

FIG. 14 is a block diagram of a computer hardware which forms the authenticating devices 100 and 200 shown in FIGS. 3 and 9, respectively. The computer includes an input device 30 that receives an input of data from the user, a monitor 31, a random access memory (RAM) 32, a read only memory (ROM) 33, a medium reader 34 that reads computer programs from a medium recording various computer programs, a network interface 35 that carries out data communication between the computer and other devices, a reader/writer 36 that reads data from and writes data to the IC card, a CPU 37, and a hard disk drive (HDD) 38, which are connected by a bus 39.

If the computer is the authenticating device 100, an authenticating process program 38b which exhibits functions similar to the authenticating device 100, is stored in the HDD 38. The CPU 37 reads the authenticating process program 38b from the HDD 38 and executes the authenticating process program 38b to start an authenticating process 37a which realizes the functions of the functional components of the authenticating device 100. The authenticating process 37a corresponds to the authenticating-insertion-count registering processor 160a, the registered-insertion count registering processor 160b, and the authenticating processor 160c shown in FIG. 3.

Various types of data 38a which is used by the functional components of the authenticating processor 100 is stored in the HDD 38. Apart from storing the data 38a in the HDD 38, the CPU 37 reads the data 38a from the HDD 38, stores the data 38a in the RAM 32, and uses data 32a stored in the RAM 32 to execute the authenticating process. The data 32a and 38a correspond to the authenticating insertion-count data 150a, the authentication data table 150b, and the registered insertion-count data 150c shown in FIG. 3.

If the computer is the authenticating device 200, the authenticating process program 38b which exhibits functions similar to the authenticating device 200 is stored in the HDD 38. The CPU 37 reads the authenticating process program 38b from the HDD 38 and executes the authenticating process program 38b to start the authenticating process 37a which realizes the functions of the functional components of the authenticating device 200. The authenticating process 37a corresponds to the authenticating-insertion-interval registering processor 260a, the registered insertion-interval registering processor 260b, and the authenticating processor 260c shown in FIG. 9.

Various types of data 38a which is used by the functional components of the authenticating processor 200 is stored in the HDD 38. Apart from storing the data 38a in the HDD 38, the CPU 37 reads the data 38a from the HDD 38, stores the data 38a in the RAM 32, and uses data 32a stored in the RAM 32 to execute the authenticating process. The data 32a and 38a correspond to the authenticating insertion-interval data 250a, the authentication data table 250b, and the registered insertion-interval data 250c shown in FIG. 9.

The authenticating process program 38b is not necessarily stored in the HDD 38 from the beginning. For example, the authenticating process program 38b may be stored in a “portable physical medium” such as a flexible disk (FD), a CD-ROM, a DVD, a magnetic optical disk, an IC card to be inserted into the computer, a “fixed physical medium” such as an HDD provided inside or outside of the computer, or “another computer (or a server)” which is connected to the computer via a public line, the Internet, a local area network (LAN), a wide area network (WAN). Thus, the computer may read and execute the authenticating process program 38b stored in the media mentioned above.

According to the present invention, a fraudulent use of a computer can be easily prevented and the security of the computer can be enhanced without causing a user to execute complex operations.

According to the present invention, the security of the computer can be enhanced.

According to the present invention, by executing a dummy insertion of the IC card beyond a predetermined time period, the user can easily prevent the fraudulent use of insertion data with the over-the-shoulder hacking.

According to the present invention, the user can freely specify a timing to register insertion data and can cause the insertion data to be efficiently stored in the IC card.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium which stores therein a user-authenticating program that causes a computer to perform a user authentication by reading data stored in an integrated circuit (IC) card with a reader, the user-authenticating program causing the computer to execute:
counting a number of an insertion-and-removal of the IC card into the reader as insertion-removal data; and
executing the user authentication based on a first insertion-removal data which represents insertion-removal data stored in the IC card in advance and a second insertion-removal data which represents the insertion-removal data counted in the counting.

2. The computer-readable recording medium according to claim 1, wherein at least one of the number of the insertion-and-removal of the IC card into the reader, and a time interval of the insertion-and-removal is counted as the insertion-removal data in the counting.

3. The computer-readable recording medium according to claim 1, wherein the user authentication in the executing is executed based on the first insertion-removal data and the second insertion-removal data which is counted within a predetermined time period in the counting.

4. The computer-readable recording medium according to claim 1, the user-authenticating program further causing the computer to execute:
storing the first insertion-removal data in the IC card, wherein
at least one of the number of the insertion-and-removal of the IC card in the reader within a specified time period and the time interval of the insertion-and-removal is stored as the first insertion-removal data in the IC card in the storing.

5. A user-authenticating method in which a reader reads data stored in an integrated circuit (IC) card to perform a user authentication, comprising:
counting a number of an insertion-and-removal of the IC card into the reader as insertion-removal data; and
executing the user authentication based on a first insertion-removal data which represents insertion-removal data stored in the IC card in advance and a second insertion-removal data which represents the insertion-removal data counted in the counting.

6. The user-authenticating method according to claim 5, wherein at least one of the number of the insertion-and-removal of the IC card into the reader, and a time interval of the insertion-and-removal is counted as the insertion-removal data in the counting.

7. The user-authenticating method according to claim 5, wherein the user authentication in the executing is executed based on the first insertion-removal data and the second insertion-removal data which is counted within a predetermined time period in the counting.

8. The user-authenticating method according to claim 5, further comprising storing the first insertion-removal data in the IC card, wherein
at least one of the number of the insertion-and-removal of the IC card in the reader within a specified time period and the time interval of the insertion-and-removal is stored as the first insertion-removal data in the IC card in the storing.

9. A user-authenticating system in which a reader reads data stored in an integrated circuit (IC) card to perform a user authentication, comprising:
an insertion-removal counting unit that counts a number of an insertion-and-removal of the IC card into the reader as insertion-removal data; and
a user-authenticating unit that executes the user authentication based on a first insertion-removal data which represents insertion-removal data stored in the IC card in advance and a second insertion-removal data which represents the insertion-removal data counted in the counting.

10. A user-authenticating device in which a reader reads data stored in an integrated circuit (IC) card to perform a user authentication, comprising:
an insertion-removal counting unit that counts a number of an insertion-and-removal of the IC card into the reader as insertion-removal data; and
a user-authenticating unit that executes the user authentication based on a first insertion-removal data which represents insertion-removal data stored in the IC card in advance and a second insertion-removal data which represents the insertion-removal data counted in the counting.

11. An integrated card (IC) card which performs data communication with an IC card reader provided to a user-authenticating device that performs a user authentication, wherein
the IC card stores therein insertion-removal data that represents at least one of a number of an insertion-and-removal of the IC card itself within a predetermined time period in the IC card reader, and a time interval of the insertion-and-removal of the IC card, the IC card reader being used for the user authentication performed by the user-authenticating device.
